(19) United States
(12) Patent Application Publication
(10) Pub. No.: US 2005/0110854 A1
(43) Pub. Date: May 26, 2005

(54) Applicator assembly having a foam oil donor roll and method to control oil level thereof

(75) Inventors: Bryan J. Roof, Fairport, NY (US); David J. Gervasi, West Henrietta, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation.

(21) Appl. No.: 10/719,394

(22) Filed: Nov. 21, 2003

(51) Int. Cl. B41J 2/175

(52) U.S. Cl. 347/103; 347/88

(57) ABSTRACT

An image transfer printing apparatus, including: a member having an imaging transfer surface; an applicator assembly distributing a liquid layer onto the imaging transfer surface to produce an intermediate transfer surface; the applicator assembly including a porous member having a core, the core having openings defined therein, a liquid supply system connected to the core for supplying liquid to saturate the porous member.

### FIELD OF INVENTION

The present invention relates generally to a drum for fixing an ink image on a receiving medium and, more particularly, to applicator assembly having a foam oil donor roll and method to control oil level thereof.

### BACKGROUND OF THE INVENTION

For printing in a solid-ink printer, a common method of applying droplets of ink onto a piece of paper is to directly print the image onto the paper, i.e., a process known as direct printing. Ink jet printing systems utilizing intermediate transfer ink jet recording methods, such as that disclosed in U.S. Pat. No. 5,389,958 entitled IMAGING PROCESS and assigned to the assignee of the present application is an example of an indirect or offset printing architecture that utilizes phase change ink. A release agent application defining an intermediate transfer surface is applied by a wicking pad that is housed within an applicator apparatus. Prior to imaging, the applicator is raised into contact with the rotating drum to apply or replenish the liquid intermediate transfer surface.

Once the liquid intermediate transfer surface has been applied, the applicator is retracted and the printhead ejects drops of ink to form the ink image on the liquid intermediate transfer surface. The ink is applied in molten form, having been melted from its solid state form. The ink image solidifies on the liquid intermediate transfer surface by cooling to a malleable solid intermediate state as the drum continues to rotate. When the imaging has been completed, a transfer roller is moved into contact with the drum to form a pressurized transfer nip between the roller and the curved surface of the intermediate transfer surface/drum. A final receiving substrate, such as a sheet of media, is then fed into the transfer nip and the ink image is transferred to the final receiving substrate.

In this standard offset process, the release agent application must be applied to every print. This provides a release layer that facilitates image transfer. Therefore, unlike a typical laser printer process in which the deposition of the toner onto the paper and the fusing of the paper occurs in parallel (at the same time), the current solid-ink process operates in series.

Existing applicator assembly and oiling methods employ an impregnated foam or capillary media roll that is brought into contact with the image drum forming a nip and thereby displacing oil from the pores to the drum. It is then wiped to a consistent level using a urethane blade. The existing method results in oil levels that are too high for some applications. The high oil levels result in a variety of issues such as offset, reduced gloss, expense, reduced foam roll life etc. In response to this issue, applicants have explored using traditional RAM's to meter oil onto the image drum. Applicants have found that this method is prone to contamination (due to the solubility of the ink with silicone oil) and is an expensive design in comparison to a foam roll system.

### SUMMARY OF THE INVENTION

The present invention obviates the problems noted above by utilizing a system in which a porous oil donor roll 15 loaded to a low saturation level and the fluid level is controlled by monitoring the mass of the roll and refilling when the mass drops below a predetermined level. In the embodiment shown, this is accomplished by weighing the roll with a spring loaded rocker arm and sensor. The roll design employs a porous drip tube through the middle, and because the oil in the roll can be refilled, Applicants have found that the roll has much longer life than the method used in the current products, which rely on loading a roll with oil and counting the number of prints before replacing the roll.

Still other aspects of the present invention will become apparent to those skilled in this art from the following description, wherein there is shown and described a preferred embodiment of this invention by way of illustration of one of the modes best suited to carry out the invention. The invention is capable of other different embodiments and its details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The objects, features and advantages of the invention will become apparent upon consideration of the following detailed disclosure of the invention, especially when it is taken in conjunction with the accompanying drawings.

FIG. 1 is a diagrammatic illustration for applying a two-step transfix process in an ink jet printing system.

FIG. 2 is a schematic illustrating the applicator of the present invention.

FIG. 3 is a schematic illustrating the oiling sensor employed with the present invention.

FIG. 4 illustrates experimental data using the applicator of the present invention.

### DETAILED DESCRIPTION OF THE INVENTION

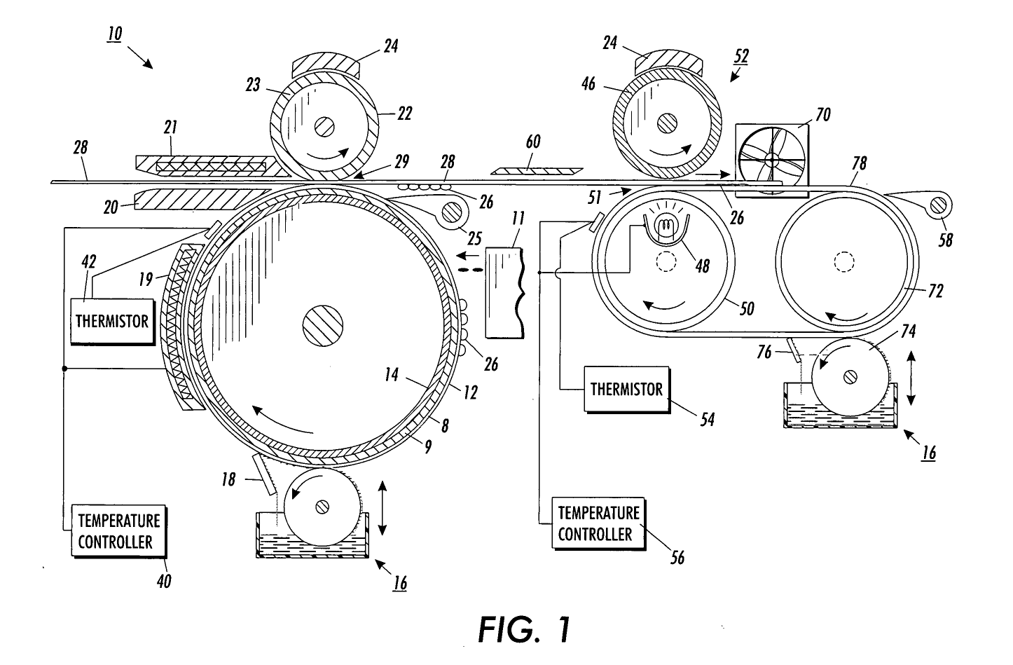

FIG. 1 discloses a diagrammatical illustration of an imaging apparatus 10 of the present invention for applying a two-step transfix process whereby a hot melt ink is printed onto an elastomer or metal transfer surface for transference to a receiving substrate and then transported through a fuser for post fusing. Referring to FIG. 1 wherein like numerals refer to like or corresponding parts throughout, there is shown a printhead 11 having ink jets supported by appropriate housing and support elements (not shown) for either stationary or moving utilization to deposit ink onto an intermediate transfer surface 12. The ink utilized is preferably initially in solid form and then changed to a molten state by the application of heat energy to raise the temperature from about 85 degrees to about 150 degrees centigrade. Elevated temperatures above this range will cause degradation or chemical breakdown of the ink. The molten ink is then applied in raster fashion from ink jets in the printhead 11 to the intermediate transfer surface 12 forming an ink image. The ink image is then cooled to an intermediate temperature and solidifies to a malleable state wherein it is transferred to a receiving substrate or media 28 and then post fused. The details of this process will now be more fully described below.

In accordance with the present invention, a drum 14 which is shown in FIG. 1 has affixed an outer compliant elastomer layer 9 defining a release surface. The intermediate transfer surface 12 is a liquid layer applied to the outer compliant elastomer layer 9 on drum 14 by contact with an applicator assembly 16. By way of example, but not of limitation, applicator assembly 16 comprises a wicking roller impregnated with a release liquid for applying the liquid and a metering blade 18 for consistently metering the liquid on the surface of the drum 14. Suitable release liquids that may be employed to form the intermediate transfer surface 12 include water, fluorinated oils, glycol, surfactants, mineral oil, silicone oil, functional oils or combinations thereof. As the drum 14 rotates about a journalled shaft in the direction shown in FIG. 1, applicator assembly 16 is raised by the action of an applicator assembly cam and cam follower (not shown) until the wicking roller is in contact with the surface of the drum 14.

Referring once again to FIG. 1, the release liquid that forms the intermediate transfer surface 12 on outer compliant elastomeric layer 9 is heated by an appropriate heater device 19. The heater device 19 may be a radiant resistance heater positioned as shown or positioned internally within the drum 14. Heater device 19 increases the temperature of the intermediate transfer surface 12 from ambient temperature to between 25 degrees to about 70 degrees centigrade or higher to receive the ink from printhead 11. This temperature is dependent upon the exact nature of the liquid employed in the intermediate transfer surface 12 and the ink used and is adjusted by temperature controller 40 utilizing thermistor 42. Ink is then applied in molten form from about 85 degrees to about 150 degrees centigrade to the exposed surface of the liquid intermediate transfer surface 12 by the printhead 11 forming an ink image 26. The ink image 26 solidifies on the intermediate transfer surface 12 by cooling down to the malleable intermediate state temperature provided by heating device 19. A receiving substrate guide apparatus 20 then passes the receiving substrate 28, such as paper or transparency, from a positive feed device (not shown) and guides it through a nip 29. Opposing arcuate surfaces of a roller 23 and the drum 14 forms the nip 29. In one embodiment, the roller 23 has a metallic core, preferably steel with an elastomer coating 22. The drum 14 having the outer compliant elastomer layer 9 continues to rotate, entering the nip 29 formed by the roller 22 with the curved surface of the intermediate transfer surface 12 containing the ink image 26. The ink image 26 is then deformed to its image conformation and adhered to the receiving substrate 28 by being pressed there against.

The ink image 26 is first applied to the intermediate transfer surface 12 on the outer compliant surface 8 or rigid layer 9 and then transfixed off onto the receiving substrate or media 28. The ink image 26 is thus transferred and fixed to the receiving substrate 28 by the pressure exerted on it in the nip 29 by the resilient or elastomeric surface 22 of the roller 23. By way of example only, the pressure exerted may be less than 800 lbf on the receiving substrate or media. Stripper fingers 25 (only one of which is shown) may be pivotally mounted to the imaging apparatus 10 to assist in removing any paper or other final receiving substrate 28 from the exposed surface of the liquid layer forming the intermediate transfer surface 12. After the ink image 26 is transferred to the receiving substrate 28 and before the next imaging, the applicator assembly 16 and metering blade 18 are actuated to raise upward into contact with the drum 14 to replenish the liquid intermediate transfer surface 12.

A heater 21 may be used to preheat the receiving surface 28 prior to the fixation of the ink image 26. The heater 21 may be set to heat from between about 60 degrees to about 200 degrees centigrade. It is theorized that the heater 21 raises the temperature of the receiving medium to between about 90 degrees to about 100 degrees centigrade. However, the thermal energy of the receiving substrate 28 is kept sufficiently low so as not to melt the ink image upon transfer to the receiving substrate 28. When the ink image 26 enters the nip 29 it is deformed to its image conformation and adheres to the receiving substrate 28 either by the pressure exerted against ink image 26 on the receiving substrate 28 or by the combination of the pressure and heat supplied by heater 21 and/or heater 19. Additionally, a heater 24 may be employed which heats the transfer and fixing roller 23 to a temperature of between about 25 degrees to about 200 degrees centigrade. Heater devices 21 and 24 can also be employed in the paper or receiving substrate guide apparatus 20 or in the transfer and fixing roller 23, respectively. The pressure exerted on the ink image 26 must be sufficient to have the ink image 26 adhere to the receiving substrate 28 which is between about 10 to about 2000 pounds per square inch, and more preferably between about 750 to about 850 pounds per square inch.

After exiting the nip 29 created by the contact of the roller 23 and the outer compliant layer 9 and drum 14, the ink image can then be thermally controlled with a thermal device 60. This thermal device 60 can heat, cool, or maintain the temperature of the receiving substrate 28 and ink image 26 which may by way of example be between 50 to 100 degrees C. The highest temperature the receiving substrate 28 and ink image 26 can be increased to in this location is dependent on the melting or flash point of the ink and/or the flash point of the receiving substrate 28. The thermal device 60 could be as simple as insulation to maintain the temperature of the ink and substrate as it exits the nip 29, or a heating and/or cooling system to add or remove thermal energy. The receiving substrate 28 and ink image 26 are then transported to a fuser 52. The fuser 52 is composed of a back-up roller 46 and a fuser roller 50. The back-up roller 46 and fuser roller 50 have metallic cores, preferable steel or aluminum, and may be covered with elastomer layers 54 and 56, respectively. The back-up roller 46 engages the receiving substrate 28 and ink image 26 on the reverse side to which the ink image 26 resides. This fuses the ink image 26 to the surface of the receiving substrate 28 so that the ink image 26 is spread, flattened, penetrated and adhered to the receiving substrate 28. The pressure exerted by the fuser may be between 100 lbf to about 2000 lbf by way of example.

When the receiving substrate 28 and ink image 26 enter the fuser 52 their temperature will change as determined by the transient heat transfer of the system during the dwell in a nip 51 formed by the fuser roller 50 and the back-up roller 46. Depending on the temperature of the back-up roller 46 and fuser roller 50, the transient temperature of the receiving substrate 28 and ink image 26 throughout their thickness can be controlled by either quenching or hot fusing. If the receiving substrate 28 and ink image 26 are brought into the fuser nip 51 hotter than the fuser roller 50 and the back-up roller 46, the ink image 26 will be quenched to a cooler temperature. This is referred to as quench fusing. If the receiving substrate 28 and ink image 26 is brought into the fuser nip 51 cooler than the fuser roller 50 and the back-up roller 46, the ink image 26 will be heated to a higher temperature, say between 75-100C. This is referred to as hot fusing. This process allows pressure to be applied to the receiving substrate 28 and ink image 26 at temperatures unachievable in the first nip 29. This is done by quenching the receiving substrate 28 and ink image 26 from a high temperature, say 80-85C down to a lower temperature, say 55-65 C where the ink image 26 has enough cohesive strength to remain intact as it exits the fuser.

Additionally, the above fusing process may also be accomplished by heating the secondary fuser nip 51 such that the ink image 26 near the surface of the receiving substrate 28 is hotter than the ink image near the surface of the fuser roller 50. This allows cool enough ink temperatures for release from the fuser roller 50 and higher temperatures near the receiving substrate 28, which increase spread, flattening, penetration and adhesion. In the case that the fuser roller 50 is a belt instead of a roller, the receiving substrate 28 and ink image 26 can be held against the belt for a distance past the nip 51 formed by the secondary fuser 50 and back-up roller 46. This allows the ink sufficient time to cool to a temperature low enough to allow it to be stripped from the belt. It should be understood that the temperature of the fuser 52 can be different to that of the receiving substrate 28 and ink image 26 and is controlled with a separate control system 56 consisting of a heater 48, and thermistor 54, as is shown in FIG. 1. Stripper fingers 58 (only one of which is shown) may be pivotally mounted to the fuser roller 50 to assist in removing any paper or receiving substrate from the surface of the fuser roller 50. The ink image 26 then cools to ambient temperature where it possesses sufficient strength and ductility to ensure its durability.

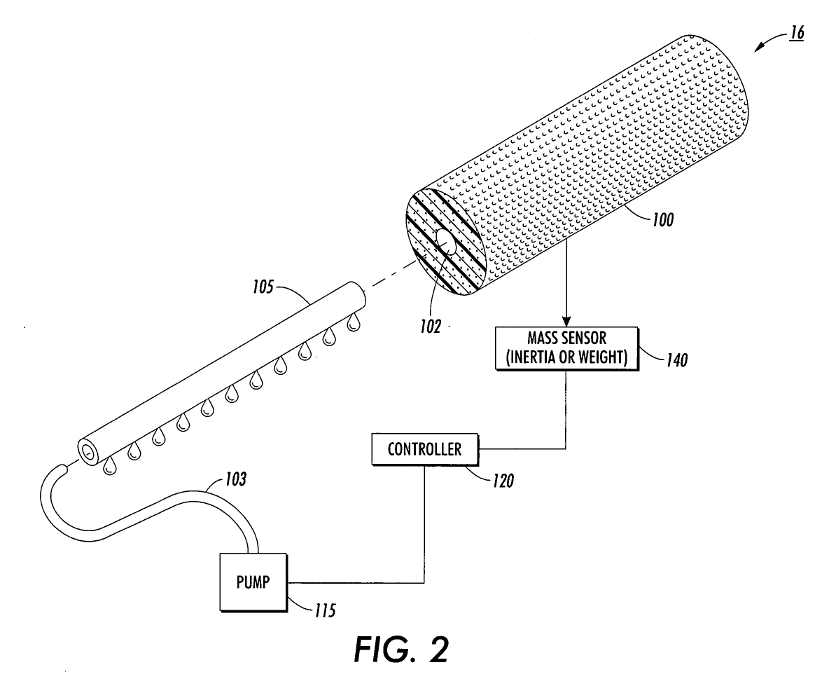

Now focusing applicator of the present invention shown in FIG. 2, there is provided a foam oiling roll 100 having a core 102 with an internal porous drip tube 105 which is inserted in core 102. The oil level in the foam roll 100 is controlled by controller 120 which is in communication with mass sensor 140 and pump 115. Controller activates pump 115 to pumping oil to the tube 103 when the amount of oil in the roll falls below a desired value which is determined by mass sensor 140.

The present device attempts to provide a method of controlling oil levels using a metered supply from a foam roll. It has been found that if a foam roll is impregnated such that it has a low level of oil saturation (i.e. less than fully saturated), it gives up less oil to the image drum/metering blade combination, but still does it at a uniform level. The drawback to this is that if the oil level starts out low in the foam roll, then the life of the roll is severely diminished. This invention incorporates the use of an internal porous drip tube to supply oil to the roll at controlled rates where the signal to supply oil is provided by determining the amount of oil in the roll and turning the oil pump on when the amount goes below a predetermined level.

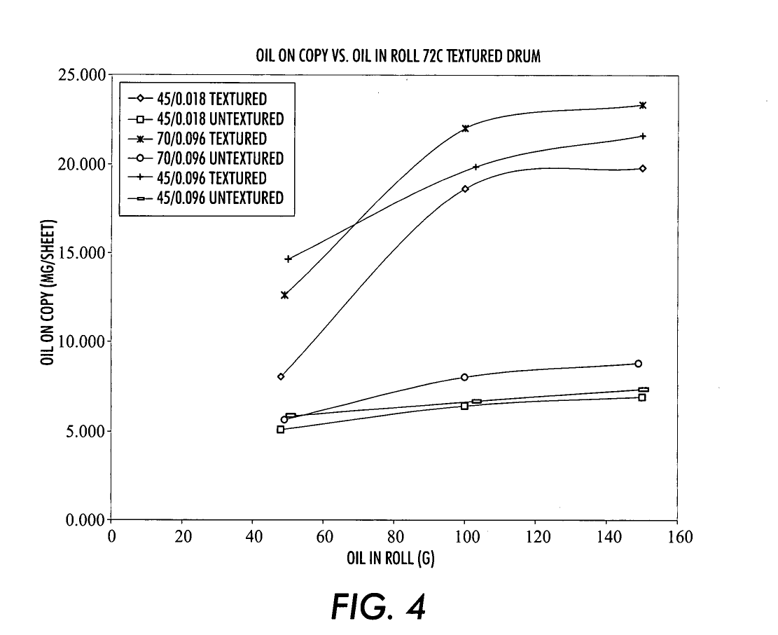

FIG. 4 shows the comparison between foam rolls loaded with different oil at different amounts of impregnation vs. the oil on copy as measured by ICP analysis. As can be seen, there are two sets of curves. One set shows the effect of reducing foam loading on a smooth image drum, the other shows reduced level on a textured drum. It is likely that drums for split process solid ink (i.e. solid ink with an elastomer image drum) will have a textured surface in order to help control image quality issues such as drawback. As a result (mostly due to capillary action and the metering blade on image drum approach), the texture will inherently attempt to hold more oil. By adopting this method we can effectively negate some of the effects created by texturing the drum while still providing an inexpensive and reliably uniform solution to oiling of the solid ink image drum.

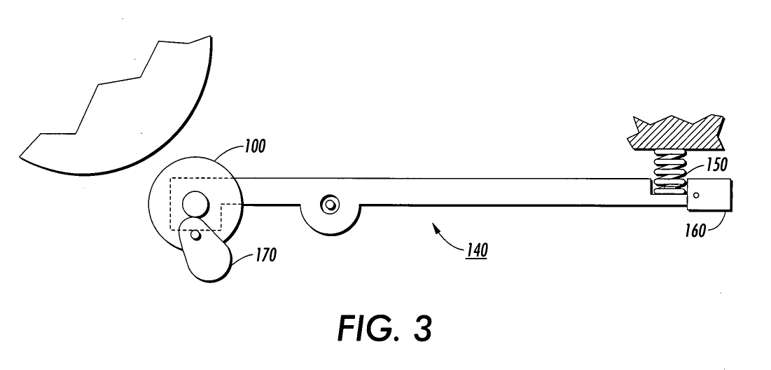

There are many possible ways in which the amount of oil in the roll can be found. One such way is illustrated in FIG. 3. This uses mass sensor 140, as the weight of the roll changes and becomes lighter, the spring 150 rotates the foam roll off of the cam 170 and thereby breaks the sensor beam produce by optical sensor 160. This triggers the controller to initiate an algorithm to start the pump pumping.

It should be clear that those skilled in the art would be able to conceive many viable options for detecting the change in the amount of oil and this is only one such method. Other methods may be to measure the torque to start or stop the foam roll and calculate the mass change from the change in inertia.

While the invention has been described above with reference to specific embodiments thereof, it is apparent that many changes, modifications and variations in the materials, arrangements of parts and steps can be made without departing from the inventive concept disclosed herein. Accordingly, the spirit and broad scope of the appended claims is intended to embrace all such changes, modifications and variations that may occur to one of skill in the art upon a reading of the disclosure. All patent applications, patents and other publications cited herein are incorporated by reference in their entirety.

1. An image transfer printing apparatus, comprising:
a member having an imaging transfer surface;
an applicator assembly distributing a liquid layer onto the imaging transfer surface to produce an intermediate transfer surface; said applicator assembly including a porous member having a core, said core having openings defined therein, a liquid supply system connected to said core for supplying liquid to saturate said porous member.

2. The image transfer printing apparatus of claim 1, further comprising means for supporting said porous member in contact with said member to release and form said liquid layer.

3. The image transfer printing apparatus of claim 1, further comprising an ink-jet printhead depositing a molten phase-change ink in a phase-change ink image on the intermediate transfer surface; and
means for transferring the phase change ink from the intermediate transfer surface to a receiving medium.

4. The image transfer printing apparatus of claim 1, further comprising a replenishing system associated with said liquid supply system, for maintaining said porous member impregnated with a predefined amount of liquid.

5. The image transfer printing apparatus of claim 4, wherein said replenishing system includes a sensing system for sensing an amount of liquid impregnated in said porous member.

6. The image transfer printing apparatus of claim 5, wherein said replenishing system includes a controller, responsive to said sensing system, for activating said liquid supply system when said porous member is impregnated with liquid below said predefined amount of liquid.

7. The image transfer printing apparatus of claim 6, wherein said sensing system includes means for sensing mass of said porous member and generating a signal indicative of the amount of liquid impregnated in said porous member.

8. The image transfer printing apparatus of claim 1, wherein said porous member is a foam roller.

9. The image transfer printing apparatus of claim 1, wherein said member is an imaging member.

10. The image transfer printing apparatus of claim 1, wherein said member is a fuser member.

11. A printing apparatus, comprising:
a member having an imaging transfer surface;
an applicator assembly distributing a liquid layer onto the imaging transfer surface to produce an intermediate transfer surface; said applicator assembly including a porous member having a core, said core having openings defined therein, a liquid supply system connected to said core for supplying liquid to saturate said porous member.

12. The printing apparatus of claim 11, further comprising means for supporting said porous member in contact with said member to release and form said liquid layer.

13. The printing apparatus of claim 11, further comprising an ink-jet printhead depositing a molten phase-change ink in a phase-change ink image on the intermediate transfer surface; and
means for transferring the phase change ink from the intermediate transfer surface to a receiving medium.

14. The printing apparatus of claim 11, further comprising a replenishing system associated with said liquid supply system, for maintaining said porous member impregnated with a predefined amount of liquid.

15. The printing apparatus of claim 14, wherein said replenishing system includes a sensing system for sensing an amount of liquid impregnated in said porous member.

16. The printing apparatus of claim 15, wherein said replenishing system includes a controller, responsive to said sensing system, for activating said liquid supply system when said porous member is impregnated with liquid below said predefine amount of liquid.

17. The printing apparatus of claim 16, wherein said sensing system includes means for sensing mass of said porous member and generating a signal indicative of the amount of liquid impregnated in said porous member.

18. The printing apparatus of claim 11, wherein said porous member is a foam roller.

19. The printing apparatus of claim 11, wherein said member is an imaging member.

20. The printing apparatus of claim 11, wherein said member is a fuser member.
